(19) United States
(12) Patent Application Publication
(10) Pub. No.: US 2007/0236638 A1
(43) Pub. Date: Oct. 11, 2007

(54) PIXEL STRUCTURE, ACTIVE DEVICE ARRAY SUBSTRATE AND LIQUID CRYSTAL DISPLAY PANEL THEREOF

(76) Inventor: Chuang-Feng Wu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,563

(22) Filed: Apr. 7, 2006

(51) Int. Cl. G02F 1/1343

(52) U.S. Cl. 349/139

(57) ABSTRACT

The present invention is directed to provide a pixel structure, comprising a substrate, a scanning line, a data line, a common line, an active device and a pixel electrode. The scanning line, the common line and the data line are all disposed on the substrate, and the data line and the scanning line mark a pixel area in the substrate. The common line is substantially parallel to the scanning line, and the two sides of the common line have a plurality of branches extending outwards. The active device is electrically connected to the scanning line and the data line, and the pixel electrode is electrically connected to the active device. This pixel electrode has two openings exposing the joint of the common line and branches.

### BACKGROUND OF THE INVENTION

1. Field of Invention

This invention relates to a pixel structure, an active device array substrate and a liquid crystal display panel. More particularly, the present invention relates to the pixel structure, the active device array substrate and the liquid crystal display panel, which are suitable for laser patching.

2. Description of Related Art

A Thin Film Transistor Liquid Crystal Display (TFT LCD) includes a thin film transistor liquid crystal display panel and a back light module. The thin film transistor liquid crystal display panel is mainly composed of a thin film transistor array substrate, a color filter array substrate and a liquid crystal layer. The thin film transistor array substrate consists of thin film transistors mostly in an array arrangement, and pixel electrodes that correspond to thin film transistors in a one-to-one manner. The thin film transistor is used as the switch element of a pixel unit. In order to control the individual pixel for data display, the pixel is selected through the scan line and the data line electrically connecting to the thin film transistor, and applied with a suitable operation voltage.

FIG. 1 is a schematic view of a prior thin film transistor array substrate. Referring to FIG. 1, the thin film transistor array substrate 100 includes a substrate (not shown), a plurality of scanning lines 110, a plurality of data lines 120, a plurality of common lines 130 (only one common line is shown in the Figure), a plurality of thin film transistors 140 and a plurality of pixel electrodes 150. Among them, the scanning lines 120 and the data lines 130 are disposed in the substrate, and divide the substrate as a plurality of pixel areas 125 in an array arrangement. The common lines 130 are arranged substantially in parallel, and one scanning line 110 is disposed between two adjacent common lines 130. Each common line 130 has a plurality of branches 132 which extend outwards. Besides, the thin film transistors 140 are disposed in the pixel areas 125 respectively, and each thin film transistor 140 is electrically connected to its corresponding scanning line 110 and data line 120.

As described above, the thin film transistor array panel 100 is inevitable to have some defects, including impurities or remaining residues, generated in the manufactures processes. Therefore, branches 132 of the common line 130 may electrically connect to a part of the pixel electrode 150 (as shown in point A of the FIG. 1), and the defected pixel structure 160 is thus formed. Additionally, because the voltage of the pixel electrode 150 electrically connecting to the branches 132 of the common line 130 is the same as that of the common electrode of the color filter substrate, it is unable to drive the liquid crystal molecular. Therefore, the thin film transistor liquid crystal display will have defected spots (namely bright spots or dark spots), thus deteriorating the display quality.

However, if these display panels with defects are discarded as useless, the production costs will be significantly increased. Generally speaking, it is extremely difficult to realize the zero defect rate by improving the manufacturing processes. Hence, it is necessary to repair the defects of the liquid crystal display panels by using laser patching. Because the laser patching technology has the functions of soldering and cutting, when the laser patching technology is used to cut and separate the common line 130 and the branches 132 which are electrical connecting pixel electrode 150 in this defected pixel structure 160 along the path B, the laser also solders the pixel electrode 150 and the common line 130 together. Therefore, no voltage difference is between the pixel electrode 150 in the defected pixel structure 160 and the common electrode in the color filter substrate. As a result, it is unable to use laser patching for the prior thin film transistor array substrate 100 when the pixel electrode 150 is electrically connected to the branches 132 of common line 130.

### SUMMARY OF THE INVENTION

Accordingly, one aspect of this invention is to provide a pixel structure an active device array substrate and a liquid crystal display panel, which are suitable for laser patching, when the branch of common line is electrically connected to the pixel electrode in the active device array substrate.

In order to achieve the above purposes, this invention proposed a pixel structure, comprising a substrate, a scanning line, a data line, a common line, an active device, and a pixel electrode. The scanning line, the common line, and the data line are all disposed in the substrate, and that the data line and the scanning line in the substrate divide the substrate into pixel areas. The common line is substantially parallel to the scanning line, and the two sides of this common line have a plurality of branches which extended outwards. Besides, the active device and the pixel electrode are both disposed in the pixel area, in which the active device is electrically connected to the scanning line and the data line, and the pixel electrode is electrically connected to the active device. In addition, the pixel electrode has two openings exposing the joint of the common line and its branches.

In a preferred embodiment of this invention, the branch, for example, is close to one side of the pixel area which is parallel to the data line.

This invention also propose a active device array substrate, comprising a substrate, a plurality of scanning lines, a plurality of data lines, a plurality of common lines, a plurality of active devices and a plurality of pixel electrodes. Among them, the scanning lines and data lines are disposed in the substrate, and the data lines and scanning lines divide the substrate into a plurality of pixel areas in an array arrangement. The common lines are substantially parallel to one another, and one scanning line is disposed between two adjacent common lines. The two sides of each common line have a plurality of branches which extend outwards respectively. Besides, the active device and pixel electrode are disposed within the pixel area respectively. Each active device is electrically connected to the corresponding scanning line and data line, and each pixel electrode is electrically connected to the corresponding active device. In addition, the pixel electrode has two openings exposing the joint of the common line and the branches in each pixel area.

This invention proposed a liquid crystal display panel, comprising a liquid crystal layer, a subtend substrate and an active device array substrate as described above, in which the liquid crystal layer is disposed between the active device array substrate and the subtend substrate.

In a preferred embodiment of this invention, as described above, the branch of each common line in the active device array substrate, for example, is close to the data line.

In a preferred embodiment of this invention, as described above, the subtend substrate, for example, is a color filter substrate.

In the preceding pixel structure and active device array substrate, the active device, for example, is a thin film transistor.

In the preceding pixel structure and active device array substrate, the pixel electrode material includes a transparent conductive material.

In the preceding pixel structure and active device array substrate, the transparent electric conductive material includes the indium tin oxide (ITO) or indium zinc oxide (IZO).

According to this invention, since the opening of the pixel electrode exposes the joint of the common line and the branches, laser patching can be performed through the opening to repair the defected spots, if the pixel electrode is electrically connected to the branch of the common line.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of the prior thin film transistor array substrate.

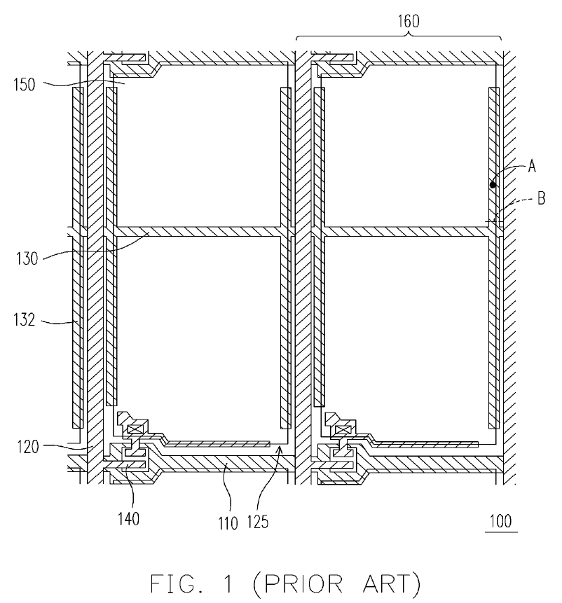

FIG. 2 is a cross-sectional schematic view of the liquid crystal display panel according to a preferred embodiment of this invention.

FIG. 3 is a schematic view of the active device array substrate in FIG. 2.

FIG. 4 illustrate laser patching to the active device array substrate according to a preferred embodiment of this invention.

### DESCRIPTION OF THE PREFERRED EMBODIMENTS

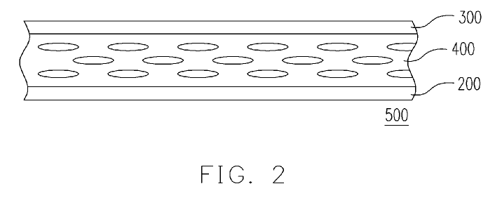

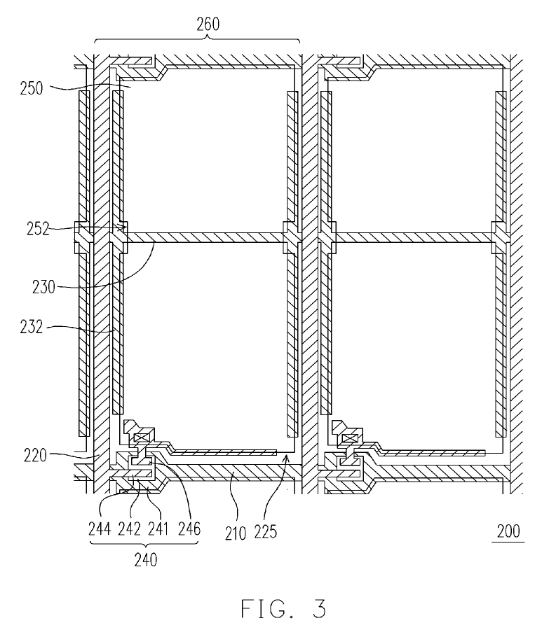

FIG. 2 is a cross-sectional schematic view of the liquid crystal display panel according to a preferred embodiment of this invention. FIG. 3 is a schematic view of the active device array substrate in FIG. 2. Referring to FIG. 2 and FIG. 3, the liquid crystal display panel 500 includes an active device array substrate 200, a subtend substrate 300 and a liquid crystal layer 400, in which the liquid crystal layer 400 is disposed between the active device array substrate 200 and the subtend substrate 300. This subtend substrate 300, for example, is a color filter substrate.

As described above, the active device array substrate 200 includes a substrate (not drawn in figure), a plurality of scanning lines 210, a plurality of data lines 220, a plurality of common lines 230 (only one is shown in the figure), a plurality of active devices 240 and a plurality of pixel electrodes 250. Among them, the scanning lines 210 and the data lines 220 are disposed on the substrate, and that the data lines 220 and scanning lines 210 divide the substrate into a plurality of pixel areas 225 in an array arrangement. The common lines 230 are substantially parallel to one another, and one scanning line 210 is disposed between two adjacent common lines 230. The two sides of each common line 230 have a plurality of branches 232 which extend outwards respectively. Besides, the active devices 240 and the pixel electrodes 250 are disposed within the pixel areas 225 respectively, in which each active device 240 is electrically connected to the corresponding scanning line 210 and data line 220, and each pixel electrode 250 is electrically connected to the corresponding active device 240. In addition, within each pixel area 225, the pixel electrode 250 has two openings 252 exposing the joint of the common line 230 and its branches 232.

In the proceeding active device array substrate 200, the pixel structure 260 is comprised of the scanning line 210, the data line 220, the common line 230, the active device 240 and the pixel electrode 250 in each pixel area 225. Among them, the active device 240, for example, is the thin film transistor which includes a gate 241, a semiconductor layer 242, a source 244 and a drain 246. The gate 241 is electrically connected to the scanning line 210, and the semiconductor layer 242 is disposed on the gate 241. The semiconductor layer 242, for example, includes a channels layer (not shown) and an ohmic contact layer above the channels layer (not shown). The source 244 and drain 246 are disposed on the semiconductor layer 242 above the gate 241, and are electrically connected to the corresponding data line 220 and pixel electrode 250 respectively.

In this embodiment, the branches 232 of each common line 230, for example, are adjacent to the data line 220, i.e. the branches 232 of the common line 230 are adjacent to opposite sides of the pixel area 225 in each pixel structure 260. Besides, the material of the pixel electrode 250, for example, is indium tin oxide, the indium zinc oxide, or other transparent or opaque electrically conductive material.

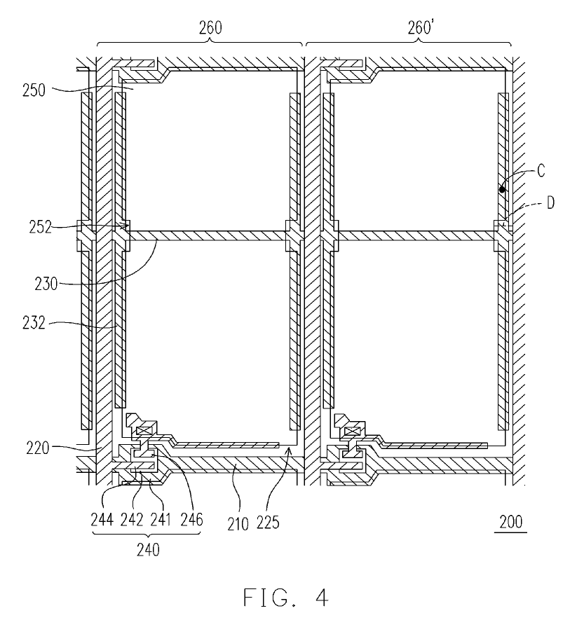

FIG. 4 illustrate laser patching to the active device array substrate according to a preferred embodiment of this invention. Please refer to FIG. 4, if defects occur in the active device array substrate 200 during the manufacture processes, defected pixel structure 260′ may be formed as the branch 232 of the common line 230 is electrically connected to the pixel electrode 250 (such as point C in FIG. 4). In the defected pixel structure 260′, because there is no voltage difference between the pixel electrode 250 electrically connecting to the branch 232 of the common line 230 and the common electrode of the subtend substrate 300, it is unable to drive liquid crystal molecular in the liquid crystal layer 400. Hence, defected spots are formed in the liquid crystal display panel 500.

In this embodiment, during the manufacture processes of the active device array substrate 200, by modifying the photomask pattern of the pixel electrode 250, the opening 252 is formed in each pixel electrode 250 corresponding to the joint of the common line 230 and its branches 232, consequently exposing the joint of the common line 230 and its branches 232. Thus, when the laser patching technology is used to cut and separates the common line 230 and the branch 232 which is electrical connected to the pixel electrode 250 along the path D in this defected pixel structure 260′, the laser will not hit on the pixel electrode 250 and the common line 230 at the same time, and the pixel electrode 250 and the common line 230 will not be soldered together.

Hence, in the active device array substrate 200 of this invention, the laser patching technique may be used to repair the defected spots in the liquid crystal display panel 500 and improve the quality of the liquid crystal display panel 500.

In summary, the pixel structure, the active device array substrate and the liquid crystal display panel in this invention at least have the following merits:

(1). Because the pixel electrode has at least an opening or a gap corresponding to the joint of the common line and its branch, if the pixel electrode is electrically connected to the branch of common line and defected spots are formed in the liquid crystal display panel, the defected spots may be repaired by using laser patching and the display quality of the liquid crystal display panel is consequently improved.

(2). Moreover, since the defected spots which are created by the pixel electrode electrically connecting to the branch of common line can be repaired, the discarded LCD panels can be decreased and the production cost can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel structure, comprising:
a substrate;
a scanning line, disposed on the substrate;
a data line, disposed on the substrate, and wherein the data line and the scanning line define a pixel area in the substrate;
a common line, disposed on the substrate, and wherein the common line is substantially parallel to the scanning line, and two sides of the common line have a plurality of branches which extend outwards;
an active device, disposed within the pixel area, and wherein the active device is electrically connected to the scanning line and the data line; and
a pixel electrode, disposed within the pixel area, and wherein the pixel electrode is electrically connected to the active device, and the pixel electrode has two openings exposing a joint of the common line and the branches.

2. The structure as claim 1, wherein the branches are adjacent to a side of the pixel area parallel to the data line.

3. The structure as claim 1, wherein the active device includes a thin film transistor.

4. The structure as claim 1, wherein a material of the pixel electrode includes a transparent conductive material.

5. The structure as claim 4, wherein the transparent conductive material includes indium tin oxide or indium zinc oxide.

6. An active device array substrate, comprising:
a substrate;
a plurality of scanning lines, disposed on the substrate;
a plurality of data lines, disposed on the substrate, and wherein the data lines and the scanning lines define the substrate into a plurality of pixel areas in an array arrangement;
a plurality of common lines, substantially parallel to one another and disposed on the substrate, and wherein one scanning line is disposed between two adjacent common lines, and two sides of the common line respectively have a plurality of branches extending outwards;
a plurality of active devices, respectively disposed within the pixel areas, and wherein each active device is electrically connected to the corresponding scanning line and the data line; and
a plurality of pixel electrodes, respectively disposed within the pixel areas, and wherein each pixel electrode is electrically connected to the corresponding active device, and each pixel electrode has two openings exposing a joint of the common line and the branches in each pixel area.

7. The structure as claim 6, wherein the branches of each common line are adjacent to the data lines.

8. The structure as claim 6, wherein the active devices include thin film transistors.

9. The structure as claim 6, wherein a material of the pixel electrode includes a transparent conductive material.

10. The structure as claim 9, wherein the transparent conductive material includes indium tin oxide or indium zinc oxide.

11. A liquid crystal display panel, comprising:
a active device array substrate, comprising;
a substrate;
a plurality of scanning lines, disposed on the substrate;
a plurality of data lines, disposed on the substrate, and wherein the data lines and the scanning lines define the substrate into a plurality of pixel areas in an array arrangement;
a plurality of common lines, substantially parallel to one another and disposed on the substrate, and wherein one scanning line is disposed between two adjacent common lines, and two sides of each common line respectively have a plurality of branches which extend outwards; a plurality of active devices, respectively disposed within the pixel areas, and wherein each active device is electrically connected to the corresponding scanning line and the data line;
a plurality of pixel electrodes, respectively disposed within the pixel areas, and wherein each pixel electrode is electrically connected to the corresponding active device, and each pixel electrode exposes a joint of the common line and the branches in each pixel area;
a subtend substrate; and
a liquid crystal layer, disposed between the active device array substrate and the subtend substrate.

12. The structure as claim 11, wherein the branches of each common line are adjacent to the data lines.

13. The structure as claim 11, wherein the active devices include thin film transistors.

14. The structure as claim 11, wherein a material of the pixel electrode include a transparent conductive material.

15. The structure as claim 14, wherein the transparent conductive material includes indium tin oxide or indium zinc oxide.

16. The structure as claim 11, wherein the subtend substrates includes a color filter substrate.
